(19) United States
(12) Patent Application Publication
(10) Pub. No.: US 2012/0042487 A1
(43) Pub. Date: Feb. 23, 2012

(54) Double locking snap hook device background of the invention

(75) Inventor: Kai Chieh Yang, Changhua (TW)

(73) Assignee: Aerohook Technology Co., Ltd.

(21) Appl. No.: 12/806,585

(22) Filed: Aug. 17, 2010

(51) Int. Cl. F16B 45/02

(52) U.S. Cl. 24/599.5

(57) ABSTRACT

A snap hook device includes a hook member having a hook throat opening formed by a base portion and a hook portion and a shank, a hinged gate pivotally coupled to the hook member and to openably close the hook throat opening, a latch member pivotally coupled to the shank with a pivot axle, the latch member includes an anchor member for engaging with a lock member of the hinged gate and the base portion and for locking the hinged gate to the hook member, and to prevent the hinged gate from being depressed to open the hook throat opening before the anchor member of the latch member is disengaged from the base portion of the hook member and the lock member of the hinged gate.

### BACKGROUND OF THE INVENTION

1. Field of the Invention

The present invention relates to a safety snap hook device, and more particularly to a safety snap hook device including a double locking structure for safely locking the hinged gate of the snap hook device and for preventing the hinged gate of the snap hook device from being opened inadvertently and for allowing the snap hook device to be easily manufactured and operated.

2. Description of the Prior Art

Typical snap hook devices comprise a hinged gate or latch member pivotally coupled to a hook body for openably closing a hook throat opening. However, the hinged gate or latch member may be depressed and actuated to open the hook throat opening inadvertently, and the strap or the belt connection will also be disengaged from the hook throat opening of the hook body inadvertently.

For safely securing or locking the strap or the belt connection to the hook body, a safety latching mechanism or locking structure may be provided and attached or coupled to the hook body for safely locking the latching mechanism or locking structure to the hook body and for preventing the snap hook from being opened inadvertently.

For example, U.S. Pat. No. 5,608,953 to Petzl et al., U.S. Pat. No. 5,791,025 to Maurice et al., U.S. Pat. No. 6,161,264 to Choate, and U.S. Pat. No. 6,588,076 to Choate disclose four of the typical snap hook devices each also comprising a finger or gate pivotally coupled to a hook body for openably closing a hook throat opening, and a safety latching mechanism or locking structure attached or coupled to the hook body for safely locking the latching mechanism or locking structure to the hook body and for preventing the snap hook from being opened inadvertently.

However, the safety latching mechanisms or locking structures normally include a tiny size or dimension or structure that may not be easily operated by the user, such that the typical snap hooks may not be easily operated by the user.

The present invention has arisen to mitigate and/or obviate the afore-described disadvantages of the conventional safety snap hook devices.

### SUMMARY OF THE INVENTION

The primary objective of the present invention is to provide a safety snap hook device including a double locking structure for safely locking the hinged gate of the snap hook device and for preventing the hinged gate of the snap hook device from being opened inadvertently and for allowing the snap hook device to be easily manufactured and operated.

In accordance with one aspect of the invention, there is provided a snap hook device comprising a hook member including a hook throat opening formed therein and defined by a base portion and a hook portion and a shank, and including a compartment formed therein and located opposite to the hook throat opening of the hook member, a hinged gate pivotally coupled to the base portion of the hook member with a pivot pin for openably closing the hook throat opening of the hook member, the hinged gate including a lock member extended therefrom, a first spring biasing member disposed between the hinged gate and the hook member for biasing and forcing the hinged gate to close the hook throat opening of the hook member, and arranged to allow the hook throat opening of the hook member to be selectively opened when the hinged gate is depressed onto the spring biasing member and forced toward the shank of the hook member, a latch member pivotally coupled to the shank of the hook member with a pivot axle for openably closing the compartment of the hook member, the latch member including an anchor member extended therefrom, and a second spring biasing member disposed between the latch member and the hook member for biasing and forcing the latch member to close the compartment of the hook member, and arranged for allowing the compartment of the hook member to be selectively opened when the latch member is depressed onto the spring biasing member and forced toward the shank of the hook member, the second spring biasing member being provided for biasing and forcing the anchor member of the latch member to be engaged between the lock member of the hinged gate and the base portion of the hook member and to lock the hinged gate to the hook member, and to prevent the hinged gate from being depressed and actuated and forced toward the shank of the hook member and to prevent the hook throat opening of the hook member from being opened inadvertently before the anchor member of the latch member is disengaged from the lock member of the hinged gate.

The anchor member of the latch member includes a lower portion for selectively engaging with the base portion of the hook member, and includes an upper portion for selectively engaging with the lock member of the hinged gate and for locking the hinged gate to the hook member.

The hinged gate includes a pair of lock members extended therefrom, and the lock members include a relatively decreased distance for engaging into the latch member and for engaging with the upper portion of the anchor member, and for snugly engaging with the shank of the hook member.

The latch member includes a relatively narrowed upper portion for snugly engaging with the shank of the hook member. The hook member includes a tongue extended from the hook portion, and the hinged gate includes an orifice formed therein for engaging with the tongue and for anchoring and positioning a free end of the hinged gate to the hook portion of the hook member.

The hook member includes a stem extended from the shank, and an eye device rotatably coupled to the stem of the hook member. The eye device includes a loop member, and a base ring provided on the loop member, and the base ring includes a bore formed therein for rotatably receiving and engaging with the stem of the hook member.

The eye device includes a gasket engaged into the bore of the base ring and engaged with the stem of the hook member and secured to the stem of the hook member with a lock nut. The eye device includes a spring ring engaged with the stem of the hook member.

The hook member includes a peripheral indicating member provided around the stem and covered and shielded by the base ring before the spring ring is compressed, and the peripheral indicating member of the hook member is exposed and to be seen by a user when the spring ring is compressed.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a safety snap hook device in accordance with the present invention;

FIG. 2 is a front perspective view of the safety snap hook device;

FIG. 3 is a rear perspective view of the safety snap hook device;

FIG. 4 is a partial cross sectional view of the safety snap hook device;

FIG. 5 is an enlarged partial cross sectional view of the safety snap hook device; and

FIG. 6 is a further partial cross sectional view similar to FIG. 4, illustrating the operation of the safety snap hook device.

### DETAILED DESCRIPTION OF THE PREFERRED EMBODIMENT

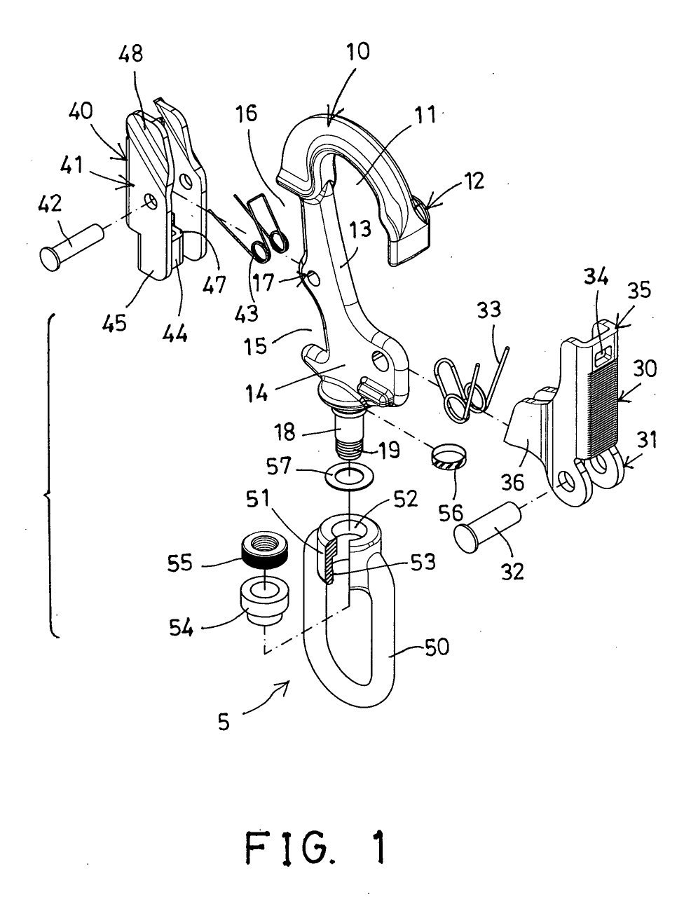

Referring to the drawings, and initially to FIGS. 1-4, a safety snap hook device in accordance with the present invention comprises a hook member 10 including a hook throat opening 11 formed therein and formed or defined by a hook portion 12 and a shank 13 and a base portion 14, and including two notches or compartments 15, 16 formed in the shank 13 and located opposite to the hook throat opening 11 and the hook portion 12 and located below and above a middle portion 17 of the shank 13 or of the hook member 10, and including a stem 18 extended downwardly from the base portion 14 of the shank 13 or of the hook member 10, in which the stem 18 includes a threaded segment or an outer thread 19 formed or provided on the outer portion of the stem 18.

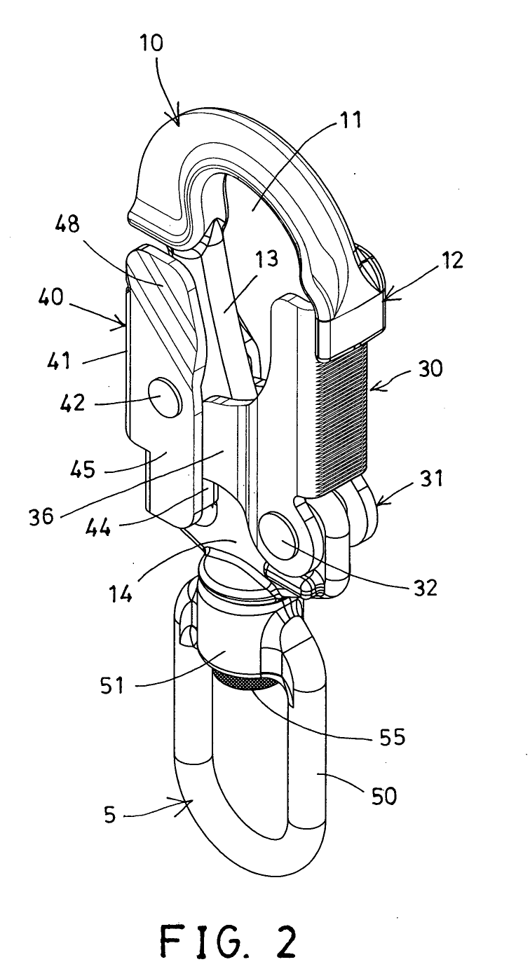

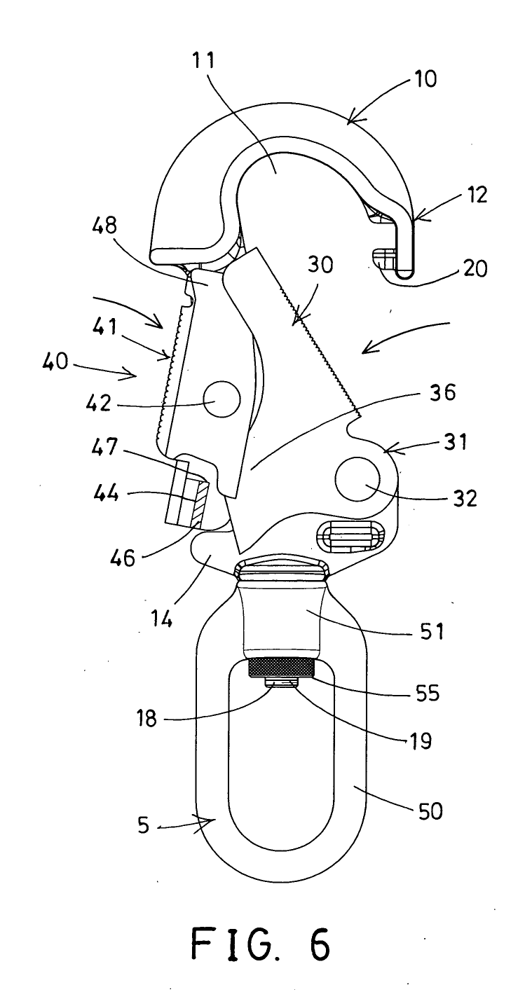

A finger or hinged gate 30 includes a lower portion or one end 31 pivotally coupled to the hook member 10, such as pivotally coupled to the base portion 14 of the shank 13 or of the hook member 10 with a pivot pin 32 for openably closing the hook throat opening 11 of the hook member 10 (FIGS. 2-4, and 6), a spring biasing member 33 is attached or engaged onto the pivot pin 32 and/or disposed between the hinged gate 30 and the base portion 14 of the shank 13 or of the hook member 10 for biasing or forcing the hinged gate 30 to block or to close the hook throat opening 11 of the hook member 10 (FIGS. 2-4), and arranged for allowing the hook throat opening 11 of the hook member 10 to be selectively opened when the hinged gate 30 is depressed onto the spring biasing member 33 and forced or moved toward the shank 13 or the hook member 10 (FIG. 6).

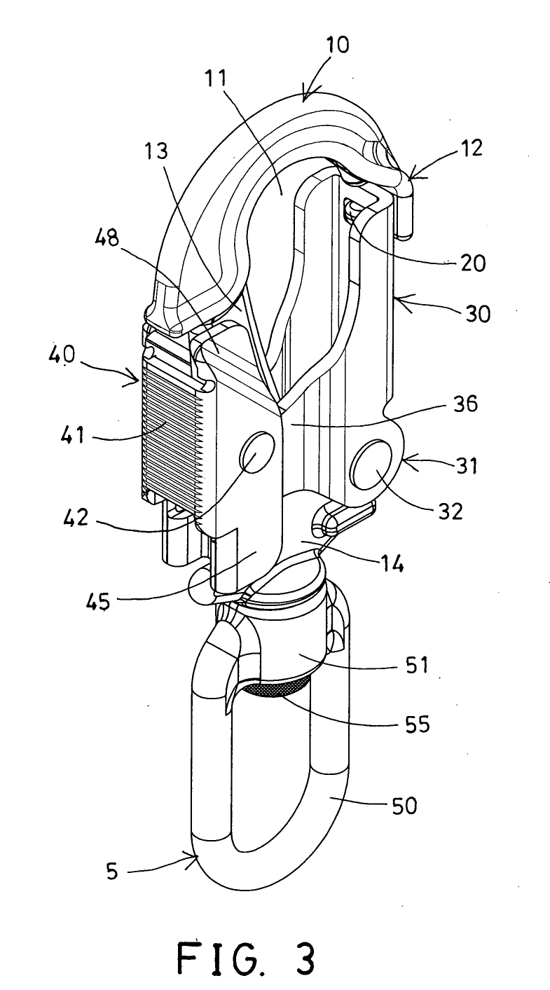

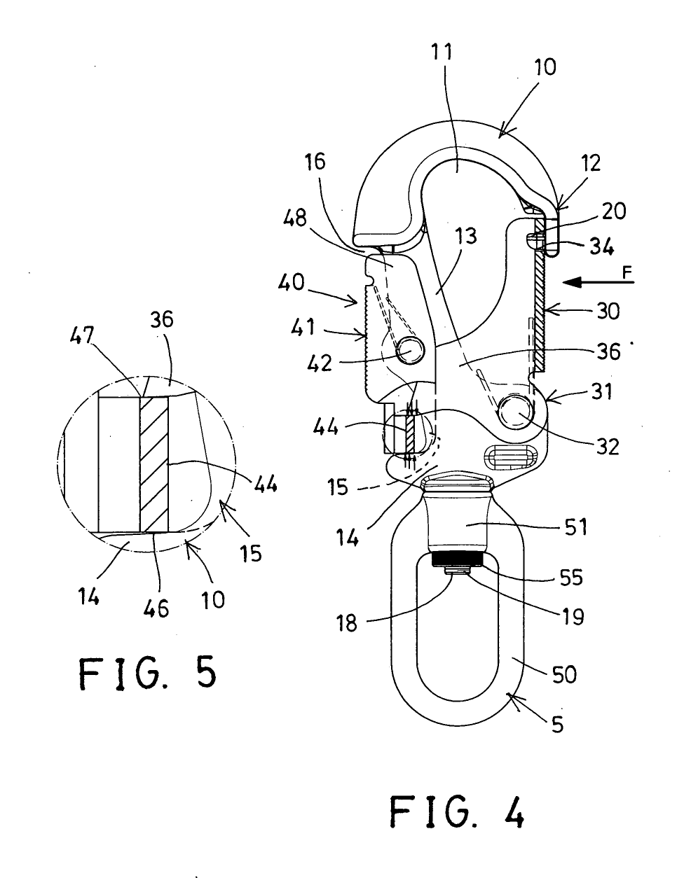

The hinged gate 30 includes an orifice 34 formed in the upper portion or the other end or free end 35 thereof for engaging with the tongue 20 that is extended from the hook portion 12 of the hook member 10 (FIGS. 3, 4) and for stably anchoring and positioning the lower portion or one end 31 of the hinged gate 30 to the hook portion 12 of the hook member 10, and includes an extension or lock member 36 extended therefrom, such as extended from the middle or lower portion 31 thereof, and extended toward or into the compartment 15 that is formed in the shank 13 and located close to the base portion 14 of the hook member 10.

A finger or handle or latch member 40 includes a lower or middle portion 41 pivotally coupled to the hook member 10, such as pivotally coupled to the middle portion 17 of the shank 13 with a pivot axle 42 for openably closing the compartment 16 of the hook member 10, or for allowing the latch member 40 to be pivoted or rotated relative to the hook member 10 and to be pivoted and engaged into the compartment 16 of the hook member 10, another spring biasing member 43 is attached or engaged onto the pivot axle 42 and/or disposed between the latch member 40 and the shank 13 or the hook member 10 for biasing or forcing the latch member 40 to block or to close the compartment 16 of the hook member 10 (FIGS. 2-4).

The latch member 40 and the hook member 10 are arranged for allowing the compartment 16 of the hook member 10 to be selectively opened when the latch member 40 is depressed onto the spring biasing member 43 and forced or moved toward the shank 13 or the hook member 10 (FIG. 6). The latch member 40 includes an extension or anchor member 44 extended therefrom, such as extended from the middle or lower portion 45 thereof, and arranged to be engaged into the lower compartment 15 of the hook member 10 (FIGS. 4, 5), and arranged to be engaged with or between the lock member 36 of the hinged gate 30 and the base portion 14 of the hook member 10.

As also shown in FIGS. 4 and 5, the anchor member 44 includes a lower portion 46 for selectively engaging with the base portion 14 of the hook member 10, and an upper portion 47 for selectively engaging with the lock member 36 of the hinged gate 30 and for locking the hinged gate 30 to the hook member 10 and for preventing the hinged gate 30 from being depressed or actuated onto the spring biasing member 33 and for preventing the hinged gate 30 from being forced or moved toward the shank 13 or the hook member 10 and thus for preventing the hook throat opening 11 of the hook member 10 from being opened inadvertently by children or the like.

In operation, as shown in FIG. 6, when the latch member 40 is depressed or actuated onto the spring biasing member 43, the anchor member 44 of the latch member 40 may be moved or disengaged from the lock member 36 of the hinged gate 30, at this moment, the hinged gate 30 is released and may be depressed or actuated onto the spring biasing member 33 and may be forced or moved toward the shank 13 or the hook member 10 in order to open the hook throat opening 11 of the hook member 10 and for allowing the strap or the belt connection (not shown) to be engaged into or disengaged from the hook throat opening 11 of the hook member 10.

As shown in FIGS. 2-4, when the latch member 40 is released, the latch member 40 will be biased by the spring biasing member 43 to block or to close the compartment 16 of the hook member 10, and to engage the anchor member 44 of the latch member 40 between the lock member 36 of the hinged gate 30 and the base portion 14 of the hook member 10, and thus to lock the hinged gate 30 to the hook member 10 and in order to prevent the hinged gate 30 from being depressed or actuated or forced or moved toward the shank 13 or the hook member 10 and thus for preventing the hook throat opening 11 of the hook member 10 from being opened inadvertently by children or the like.

It is preferable that the hinged gate 30 includes a pair of lock members 36 extended therefrom, and the lock members 36 include a relatively decreased space or distance for allowing the lock members 36 of the hinged gate 30 to be selectively engaged into the latch member 40 and engaged with the upper portion 47 of the anchor member 44 of the latch member 40, and for allowing the lock members 36 of the hinged gate 30 to be snugly or smoothly engaged with the shank 13 of the hook member 10. The latch member 40 includes a relatively decreased or narrowed upper portion 48 for snugly or smoothly engaging with the shank 13 of the hook member 10.

The snap hook device further includes an eye device 5 having a ring or loop member 50, and a base ring 51 formed integral or attached or provided on the upper portion of the loop member 50, and the base ring 51 includes a bore 52 formed therein for pivotally or rotatably receiving or coupling or engaging with the stem 18 of the hook member 10, and includes a peripheral recess or shoulder 53 formed or provided therein and communicating with the bore 52 of the base ring 51 for engaging with a ball bearing device or gasket 54 and for rotatably and smoothly coupling the loop member 50 of the eye device 5 to the stem 18 of the hook member 10. The gasket 54 is engaged into the bore 52 and the peripheral shoulder 53 of the base ring 51 stably anchoring and positioning the base ring 51 of the eye device 5 to the stem 18 of the hook member 10.

The gasket 54 is also pivotally or rotatably coupled or engaged with the stem 18 of the hook member 10 and mounted or secured to the stem 18 of the hook member 10 with a fastener or lock nut 55, and includes a ring-shaped spring biasing member or a spring ring 57 engaged onto or with the stem 18 of the hook member 10 for providing a spring biasing force between the stem 18 or the base portion 14 of the hook member 10 and the base ring 51 of the eye device 5, and includes a circular or peripheral indicating member 56 provided and attached or mounted or secured onto or around the root portion of the stem 18 and having a high-visibility color different from that of the shank 13 and the stem 18 and offered as an increased visual aid to verify whether the indicating member 56 of the stem 18 is exposed or not.

In operation, when the spring ring 57 is still in good order or has not been compressed or deformed or damaged, the spring ring 57 may be maintained or engaged in and covered or shielded by the base ring 51 of the eye device 5 for preventing the indicating member 56 from being seen by the users. When a great over weight has been applied to the hook member 10 and when the spring ring 57 may not sustain the weight, at this moment, the spring ring 57 will be deformed or damaged and compressed, and the indicating member 56 may then be exposed and seen by the users, and for allowing the high-visibility color of the indicating member 56 to offer as an increased visual aid to verify whether the spring ring 57 has been compressed or deformed or damaged or not, and for allowing the spring ring 57 to be changed or replaced with the new ones.

Accordingly, the safety snap hook device in accordance with the present invention includes a double locking structure for safely locking the snap hook device and for preventing the snap hook device from being opened inadvertently and for allowing the snap hook device to be easily manufactured and operated.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A snap hook device comprising:
a hook member including a hook throat opening formed therein and defined by a base portion and a hook portion and a shank, and including a compartment formed therein and located opposite to said hook throat opening of said hook member,
a hinged gate pivotally coupled to said base portion of said hook member with a pivot pin for openably closing said hook throat opening of said hook member, said hinged gate including a lock member extended therefrom,
a first spring biasing member disposed between said hinged gate and said hook member for biasing and forcing said hinged gate to close said hook throat opening of said hook member, and arranged to allow said hook throat opening of said hook member to be selectively opened when said hinged gate is depressed onto said spring biasing member and forced toward said shank of said hook member,
a latch member pivotally coupled to said shank of said hook member with a pivot axle for openably closing said compartment of said hook member, said latch member including an anchor member extended therefrom, and
a second spring biasing member disposed between said latch member and said hook member for biasing and forcing said latch member to close said compartment of said hook member, and arranged for allowing said compartment of said hook member to be selectively opened when said latch member is depressed onto said spring biasing member and forced toward said shank of said hook member, said second spring biasing member being provided for biasing and forcing said anchor member of said latch member to be engaged between said lock member of said hinged gate and said base portion of said hook member and to lock said hinged gate to said hook member, and to prevent said hinged gate from being depressed and actuated and forced toward said shank of said hook member and to prevent said hook throat opening of said hook member from being opened inadvertently before said anchor member of said latch member is disengaged from said lock member of said hinged gate.

2. The snap hook device as claimed in claim 1, wherein said anchor member of said latch member includes a lower portion for selectively engaging with said base portion of said hook member, and includes an upper portion for selectively engaging with said lock member of said hinged gate and for locking said hinged gate to said hook member.

3. The snap hook device as claimed in claim 2, wherein said hinged gate includes a pair of lock members extended therefrom, and said lock members include a relatively decreased distance for engaging into said latch member and for engaging with said upper portion of said anchor member, and for snugly engaging with said shank of said hook member.

4. The snap hook device as claimed in claim 1, wherein said latch member includes a relatively narrowed upper portion for snugly engaging with said shank of said hook member.

5. The snap hook device as claimed in claim 1, wherein said hook member includes a tongue extended from said hook portion, and said hinged gate includes an orifice formed therein for engaging with said tongue and for anchoring and positioning a free end of said hinged gate to said hook portion of said hook member.

6. The snap hook device as claimed in claim 1, wherein said hook member includes a stem extended from said shank, and an eye device rotatably coupled to said stem of said hook member.

7. The snap hook device as claimed in claim 6, wherein said eye device includes a loop member, and a base ring provided on said loop member, and said base ring includes a bore formed therein for rotatably receiving and engaging with said stem of said hook member.

8. The snap hook device as claimed in claim 7, wherein said eye device includes a gasket engaged into said bore of said base ring and engaged with said stem of said hook member and secured to said stem of said hook member with a lock nut.

9. The snap hook device as claimed in claim 8, wherein said eye device includes a spring ring engaged with said stem of said hook member.

10. The snap hook device as claimed in claim 9, wherein said hook member includes a peripheral indicating member provided around said stem and covered and shielded by said base ring before said spring ring is compressed, and said peripheral indicating member of said hook member is exposed and to be seen by a user when said spring ring is compressed.
